(19) United States
(12) Patent Application Publication
(10) Pub. No.: US 2009/0171654 A1
(43) Pub. Date: Jul. 2, 2009

(54) SYSTEMS AND METHODS FOR RENDERING MULTILINGUAL INFORMATION ON AN OUTPUT DEVICE

(76) Inventor: Wanda Hudgins Spain, Lilburn, GA (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/183,660

(22) Filed: Jul. 31, 2008

Related U.S. Application Data
(63) Continuation of application No. 10/293,922, filed on Nov. 13, 2002, now abandoned.
(60) Provisional application No. 60/338,804, filed on Nov. 13, 2001.

(51) Int. Cl. G06F 17/20; G06F 17/30

(52) U.S. Cl. 704/7; 707/4; 715/234; 715/235; 715/702; 705/28; 707/E17.015

(57) ABSTRACT

The present invention is directed to systems and methods for rendering multilingual information encoded in human-readable and machine-readable format on an output device. A typical system according to the present invention can include a system data store (SDS) and a system processor in communication with the SDS. A search term is entered, typically by a user. A database of multilingual information in the SDS is accessed based upon the entered search term to retrieve context specific translation information. In some instance, a selection is made among multiple potential translations within the translation information. At least a portion of the translation information is provided in a format compatible with a selected output device.

### CROSS-REFERENCE TO RELATED PATENT APPLICATIONS

This application is a continuation application under 37 CFR § 1.53(b) of U.S. patent application Ser. No. 10/293,922, filed Nov. 13, 2002, which claims the benefit, pursuant to 35 U.S.C. §119(e), of Applicant's provisional U.S. Patent Application Ser. No. 60/338,804, filed Nov. 13, 2001 entitled “Multi-Lingual Bar Code Printing System and Method,” both applications are hereby incorporated by reference in their entirety for all purposes.

### BACKGROUND

1. Field

This invention relates to systems and methods for rendering multilingual information on an output device. More particularly, the invention relates to rendering multilingual information on an output device in human-readable and/or machine-readable formats.

2. Description of Related Art

Automatic identification technology is prevalent in every area of modern commerce and government. Examples of common auto identification technologies include bar code symbologies, read/write devices and RF devices. Auto identification technologies allow multilingual information to be imprinted onto various objects, in both human-readable and machine-readable form. An item imprinted with auto identification technology, such as goods in commerce, can pass through several countries and can be handled by different people who understand different languages. Therefore, the information captured by automatic identification technologies is most useful if it is encoded in more than one language.

A common auto identification technology for encoding information is bar code symbology. As shown in FIG. 1A, one of the most common bar code label types is the Universal Product Code (UPC) label 1, which is commonly applied to almost any kind of merchandise. UPC labels comprise a bar code 2 identifying a product and often include text describing the goods being sold. If the market for the goods includes people who understand more than one language, then the retailer has a competitive advantage if its UPC labels include descriptive text written in the language of the customers. For example, a Chinese foods market in the United States would have an advantage if its UPC labels included both text written in English 3 and text written in Chinese characters 4.

Compliance labels 5 (such as depicted in FIG. 1B) are bar code labels applied to goods that comprise information necessary to meet a standard issued by a government or a business. For example, major retailers have issued standards for label format and content that must be met by any supplier that hopes to do business with the retailer. Also, many governments have issued standards for compliance labels to be applied to all goods entering their respective countries to help prevent smuggling. Businesses involved in international distribution must meet standards issued by both the retailers receiving goods and the governments to which the goods are exported.

Many compliance label standards require information in text and bar coded information that allows for use of an automated identification system. Such standards often require that each unit of merchandise be labeled with a label that includes: a description of goods being shipped in the language of the country from which the goods are being shipped, a description of goods in the language of the country to which the goods are being shipped, a first bar code that includes a serial number of the goods and a bar code that includes information regarding shipping instructions. For example, one wishing to supply a retailer in the Ukraine with goods may be required to ship the goods under a label that includes a description of the goods in English, a second description of the goods in Ukrainian (in the Cyrillic alphabet), a bar code that includes the retailer's serial number and a bar code that includes instructions for shipping the goods to the retailer's distribution point.

As shown in FIG. 1B, a complex compliance label 5 for shipping dolls to Israel might include a UPC bar code 6 for identifying a product, a second bar code 7 (in a second bar code standard such as code 3 of 9, shown here) encoding shipping information, descriptive Hebrew text 8 and similar text 9 in English. There are many different standards for compliance labels, many of which are quite complex, as is illustrated by the depiction of the label in FIG. 1C, the packing slip in FIG. 1D, and the invoice in FIG. 1E. Each form of compliance documentation shown in these figures includes text translated to multiple languages and one or more bar codes in varying symbologies.

Current systems are limited in that they do not allow the user to select from several languages when generating the label or other compliance documentation. For example, if an exporter needed bar code labels for items being exported to Russia, custom bar code printing software would have to be generated that would allow the user to print bar code labels using the Cyrillic alphabet. Such software would not allow the exporter to select another language, for example Mandarin. If the exporter received an order from China requiring bar code labels in Mandarin, the exporter would have to have its label printing system custom adapted to handle Mandarin. Thus, the prior art has the disadvantage that changing languages is costly, time consuming and inefficient. Furthermore, existing systems do not afford the user opportunity to create templates for compliance documentation such as labels, or to search a multilingual database for context specific translations of words or phrases for encoding with bar codes or other automatic identification technology. Existing systems are typically limited to cutting and pasting images of pre-formatted text, as is described in the background section of U.S. Pat. No. 6,056,195 which was issued May 2, 2000 to Wanda Hudgins Spain, the disclosure of which is hereby incorporated herein for all purposes.

Current technology does not provide methods or systems for searching a database of multilingual information for words or phrases that suit a specific context, selecting some portion of the data and rendering an output of multilingual information encoded in human-readable and/or machine-readable format.

### SUMMARY

The present invention is directed to systems and methods for rendering multilingual information encoded in human-readable and machine-readable format on an output device. One preferred embodiment according to the present invention includes a system processor that supports the desired functionality as described in detail below and a system data store (SDS) that stores data associated with this functionality such as true type fonts corresponding to various languages (e.g. Chinese characters, the Cyrillic alphabet, etc.), document templates, and a multilingual database of words and phrases with context specific definitions. The system processor is in communication with the SDS.

The SDS can include multiple physical and/or logical data stores for storing the various types of information used. Data storage and retrieval functionality can be provided by either the system processor or data storage processors associated with the data store. The system processor is in communication with the SDS via any suitable communication channel(s). The system processor can include one or more processing elements that provide analysis, management, translation, tracking and/or other functionality.

Accordingly, one preferred method of rendering multilingual information on an output device includes a variety of steps that can, in certain embodiments, be executed by the environment summarized above and more fully described below or be stored as computer executable instructions in and/or on any suitable combination of computer-readable media. In accordance with one preferred embodiment of the present invention, a search term interface is provided for receiving a search term in a first language. A database of multilingual information is searched for information corresponding to the search term and a result set of information is retrieved. The result set of information can include one or more words or phrases in the first language along with a translation of the words or phrases in a second language. The information can be presented via an interface in a format that resembles a conventional dictionary entry, and can include any of the following: the function of the word described by conventional abbreviations (n. for noun, v.t. for transitive verb etc.), verb tenses, at least one context specific definition, synonyms, antonyms or other related words or phrases. A system user can select any portion of the retrieved information, for use in rendering multilingual information on an output device. The user can repeat the search and process selection to build strings of context specific translations that can be rendered on an output device. The systems and methods according to the present invention can include, or be adapted for use with, various types of output devices, as will be described more fully below.

In a preferred embodiment, the system data store contains at least one multilingual database that a user can select to search. The system data store can also provide storage for various true type language fonts and templates for the creation of compliance documentation. Templates can be preloaded into the system or can be created, modified, deleted, saved or otherwise manipulated by an individual user.

The databases can be periodically updated or tailored to suit a particular user's needs. The present invention can be adapted to allow updating of stored databases via any communications channel, including the Internet.

In another embodiment, the present invention can be adapted to facilitate inventory management functions. In this embodiment of the present invention, a user can scan an inventory of items with a handheld electronic device to collect data regarding inventory status and then transfer this data to a computer equipped a system processor and data store containing a multilingual database. Either the handheld device or the computer can generate a request to perform an inventory management function. The computer can process the data to perform an inventory management function, such as ordering replenishment of a particular stock item. Processing the data can include searching for and retrieving multilingual information from the database that corresponds to the data delivered from the handheld device, and then rendering multilingual information on an output device to facilitate fulfillment of the inventory management request.

Additional advantages of the invention will be set forth in part in the description which follows, and in part will be obvious from the description, or can be learned by practice of the invention. It is to be understood that both the foregoing general description and the following detailed description are exemplary and explanatory only and are not restrictive of the invention. The described and other advantages will become apparent from the following description of preferred embodiments and the practicing of the invention taken in conjunction with the following drawings, although variations and modifications can be effected without departing from the spirit and scope of the novel concepts of the disclosure.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1A-1E are examples of compliance documentation comprising text in more than one language and one or more bar code symbologies.

FIG. 2 is a schematic diagram of a hardware configuration of the system.

FIG. 3 depicts an interface for selecting a language.

FIGS. 4A and 4B depict multiple layers of a virtual keyboard.

FIG. 5 depicts an interface for searching a multilingual database and selecting retrieved information.

FIG. 6 depicts a sample result set retrieved in response to entry of a search term.

FIG. 7 depicts an interface for submitting a request for an update to a multilingual database via electronic mail.

FIG. 8A-8F depict an interface for selecting and specifying the properties of a bar code symbology.

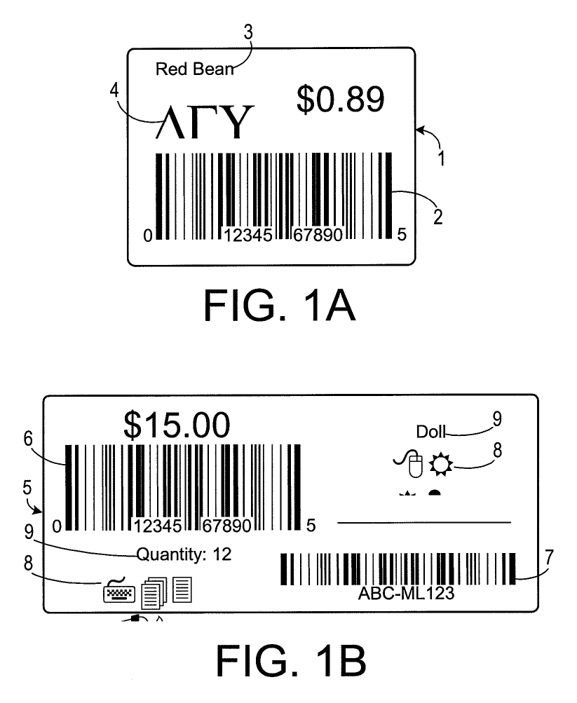

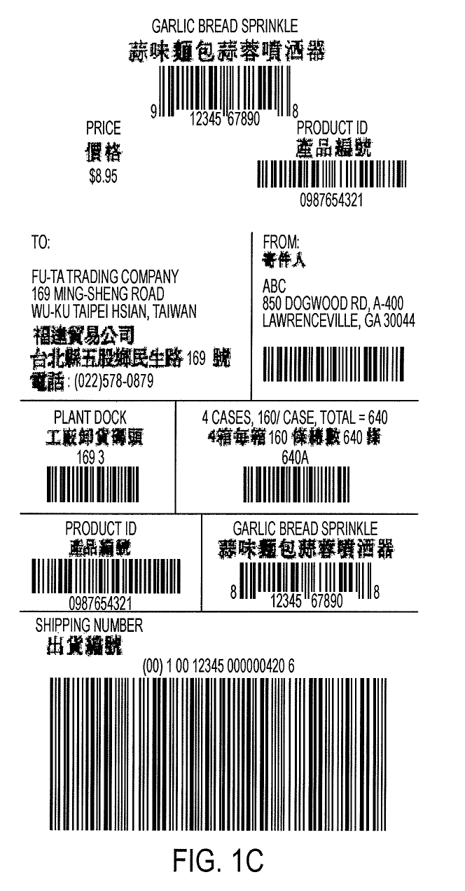

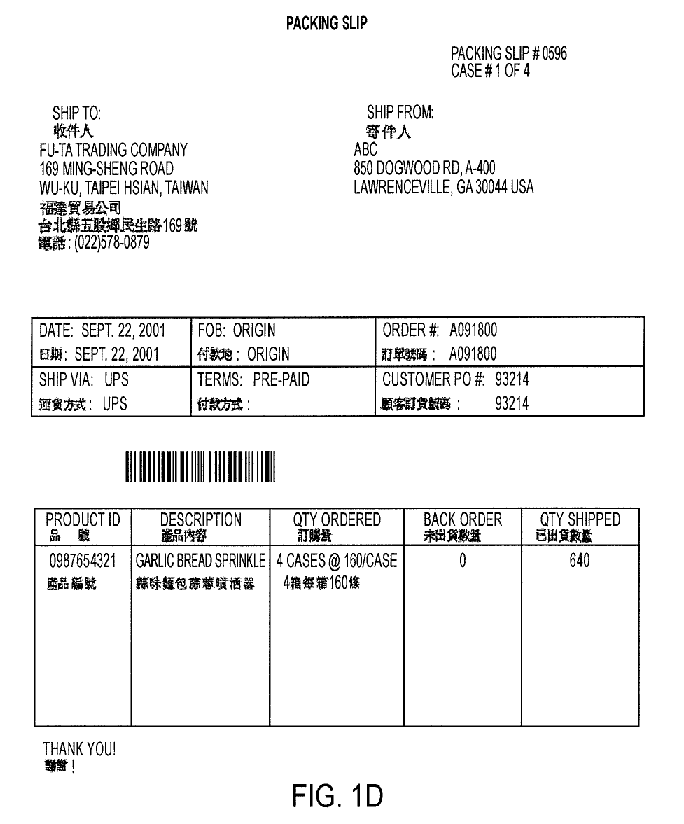

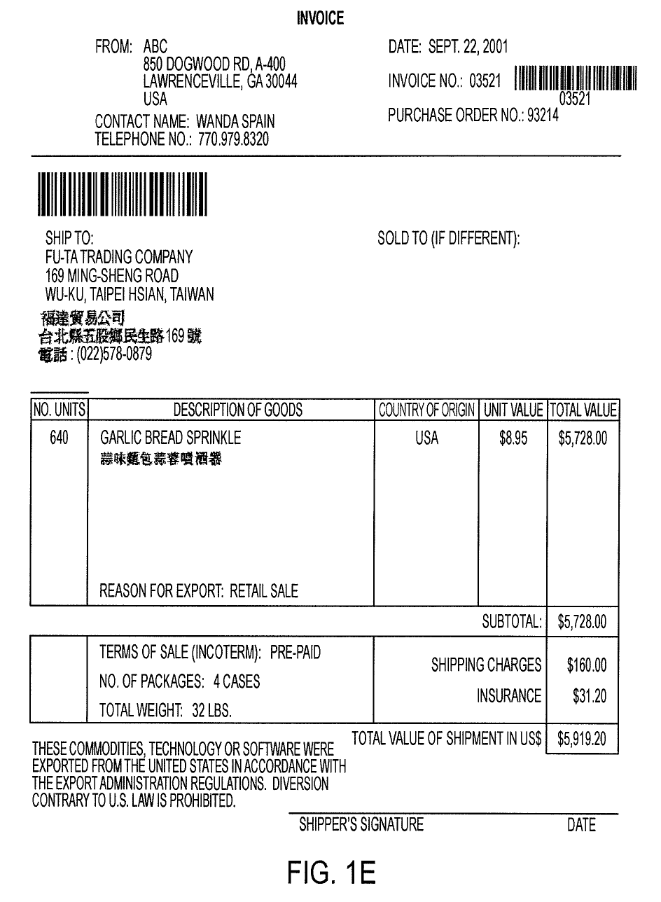

### DETAILED DESCRIPTION OF THE INVENTION

One or more preferred embodiments of the invention are now described in detail. Referring to the drawings, like numbers indicate like parts throughout the views. As used in the description herein, the meaning of “a,” “an,” and “the” includes plural reference unless the context clearly dictates otherwise. Also, as used in the description herein, the meaning of “in” includes “in” and “on” unless the context clearly dictates otherwise. Finally, as used in the description herein and throughout the claims that follow, the meanings of “and” and “or” include both the conjunctive and disjunctive and can be used interchangeably unless the context clearly dictates otherwise.

As used herein, the following terms shall be defined in accordance with the definitions provided:

The term output device shall be defined to include a monitor, a printer, a data file on one or more electronic storage media, a facsimile machine, direct parts marking equipment used with automatic identification technologies such as inkjet printing, dot peen or pin stamp, laser engraving or etching, laser marking, and electrochemical (acid) etching and equipment for imprinting data on contact read/write devices such as memory buttons, magnetic strips, radio frequency tags and chips.

The term compliance documentation shall be defined to include packing slips, invoices, labels, bills of lading, certificates of authenticity, tags, multi-part forms, or other documentation as can be required to allow passage of goods through customs in this or other countries, as these terms are understood by persons in the art and industry.

In one preferred embodiment, the present invention includes a system processor potentially including multiple processing elements. The term processing element can refer to (1) a process running on a particular piece, or across particular pieces, of hardware, (2) a particular piece of hardware, or either (1) or (2) as the context allows. Each processing element can be supported via a standard general purpose processor such as an Intel-compatible processor platforms preferably using at least one PENTIUM III, PENTIUM IV or CELERON (Intel Corp., Santa Clara, Calif.) class processor; alternative processors such as UltraSPARC (Sun Microsystems, Palo Alto, Calif.) could be used in other embodiments. The system processor can include one or more field programmable gate arrays (FPGAs) and/or application specific integrated circuits (ASICs) configured to perform at least a portion of the functionality according to the present invention. In some embodiments, the system processor can include a combination of general purpose processors, ASICs and/or FPGAs. In some embodiments, multilingual information encoding and rendering, as further described below, can be distributed across multiple processing elements.

System processors including at least one general purpose processor would run an appropriate operating system such as WINDOWS/NT, WINDOWS 2000 or WIDOWS/XP Server (Microsoft, Redmond, Wash.), Solaris (Sun Microsystems, Palo Alto, Calif.), or LINUX (or other UNIX variant). In one preferred embodiment, the WINDOWS 2000 operating system in used. In general the operating system in a preferred embodiment should be able to support double-byte characters.

The SDS could include a variety of primary and secondary storage elements. In one preferred embodiment, the SDS would include RAM as part of the primary storage; the amount of RAM should be at least 64 MB in embodiments including a computer workstation running the WINDOWS 2000 operating system. The primary storage can in some embodiments include other forms of memory such as cache memory, registers, non-volatile memory (e.g., FLASH, ROM, EPROM, etc.), etc.

The SDS can also include secondary storage including single, multiple and/or varied servers and storage elements. For example, the SDS can use internal storage devices connected to the system processor. In embodiments where a single processing element supports all of the multilingual information rendering functionality, a local hard disk drive can serve as the secondary storage of the SDS, and a disk operating system executing on such a single processing element can act as a data server receiving and servicing data requests.

It will be understood by those skilled in the art that the fonts, templates, multilingual information and other data used to render an output according to the present invention can be logically or physically segregated within a single device serving as secondary storage for the SDS; multiple related data stores accessible through a unified management system, which together serve as the SDS; or multiple independent data stores individually accessible through disparate management systems, which can in some embodiments be collectively viewed as the SDS. The various storage elements that comprise the physical architecture of the SDS can be centrally located, or distributed across a variety of diverse locations.

The architecture of the secondary storage of the system data store can vary significantly in different embodiments. In several embodiments, database(s) are used to store and manipulate the data; in some such embodiments, one or more relational database management systems, such as DB2 (IBM, White Plains, N.Y.), SQL Server (Microsoft, Redmond, Wash.), ACCESS (Microsoft, Redmond, Wash.), ORACLE 8i (Oracle Corp., Redwood Shores, Calif.), Ingres (Computer Associates, Islandia, N.Y.), MySQL (MySQL AB, Sweden) or Adaptive Server Enterprise (Sybase Inc., Emeryville, Calif.), can be used in connection with a variety of storage devices/file servers that can include one or more standard magnetic and/or optical disk drives using any appropriate interface including, without limitation, IDE and SCSI. In some embodiments, a tape library such as Exabyte X80 (Exabyte Corporation, Boulder, Colo.), a storage attached network (SAN) solution such as available from (EMC, Inc., Hopkinton, Mass.), a network attached storage (NAS) solution such as a NetApp Filer 740 (Network Appliances, Sunnyvale, Calif.), or combinations thereof can be used. In other embodiments, the data store can use database systems with other architectures such as object-oriented, spatial, object-relational or hierarchical.

Instead of, or in addition to, those organization approaches discussed above, certain embodiments can use other storage implementations such as hash tables or flat files or combinations of such architectures. Such alternative approaches can use data servers other than database management systems such as a hash table look-up server, procedure and/or process and/or a flat file retrieval server, procedure and/or process. Further, the SDS can use a combination of any of such approaches in organizing its secondary storage architecture.

The SDS communicates with the system processor by one or more communication channels. Multiple channels can be involved in some embodiments for supporting communication between processing elements of the system processor and portions of the SDS. Such channels can include without limitation computer network, direct dial-up connection, dedicated connection, direct or indirect connection such as via a bus connection, parallel or serial connection, USB connection, null modem connection or wireless connection utilizing an appropriate communication protocol such as BLUETOOTH, IRDA, 802.11b or other suitable channel as would be known to those skilled in the art.

The embodiments described above are given as illustrative examples only. It will be readily appreciated by those skilled in the art that many deviations can be made from the specific embodiments disclosed in this specification without departing from the scope of the invention. A preferred embodiment of the invention is now described in detail.

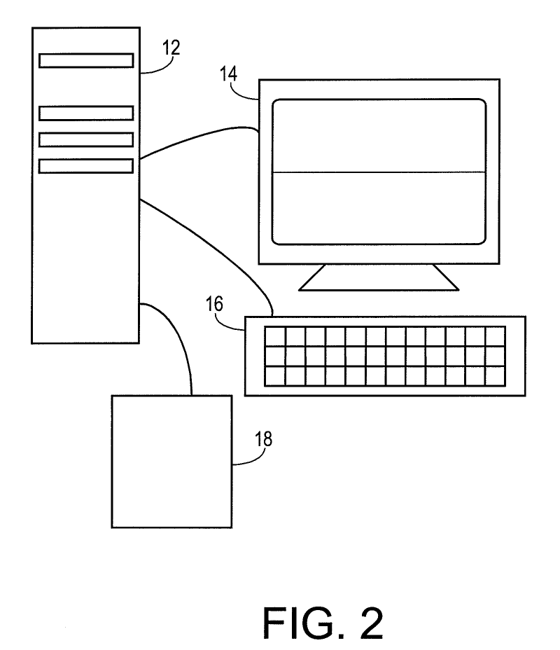

As shown in FIG. 2A, the hardware used in a preferred embodiment of the invention includes a computer 12 coupled to a video monitor 14, a keyboard 16 and an output device 18, as that term is defined above. Data entry can be accomplished through the keyboard 16, or through other conventional means, such as a mouse, a virtual keyboard, a touch screen or through a data transmission to the computer 12.

In a preferred embodiment, the inventions incorporates the label design tool LABEL MATRIX, from Teklynx International Co., 1200 West Park Place Milwaukee, Wis. U.S.A. 53224 and fonts needed to support various languages are licensed from DataCal Corp., 531 East Elliot Rd., Chandler, Ariz. 85225. One of skill in the art will appreciate, however, that the scope of the claims is not limited to any particular label design tool, and that the present invention can be implemented with any label design tool, warehouse management system, inventory shipping and receiving system, or other inventory tracking system.

In a preferred embodiment, the computer 12 displays a graphical user interface on monitor 14 that employs a notebook metaphor. The virtual notebook comprises a plurality of tabs with each tab corresponding to different functionality of the invention, through which the user can configure the invention for rendering varying outputs of multilingual information for use by automatic identification technology.

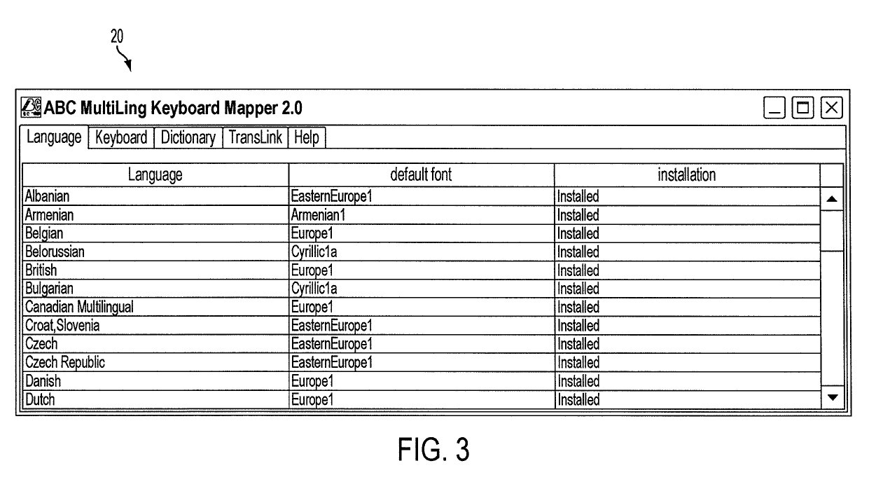

Referring to FIG. 3, an exemplary graphical interface for a preferred embodiment of the invention is shown. The interface is in the form of a notebook with five tabs—Language, Keyboard, Dictionary, Translink and Help. When the Language tab is selected, as is shown in FIG. 3, the system displays a scrollable list of languages 20 from which the user can select. In response to selection of a language, the system is automatically configured to create a virtual keyboard with a layout corresponding to the language selection. For example, selection of the Bulgarian language will cause the creation of a virtual keyboard corresponding to the Cyrillic alphabet, and any human-readable output (e.g. text) rendered under this configuration will be created using an appropriate Cyrillic font. The system will further indicate whether the language font or fonts necessary to support a particular language has been installed.

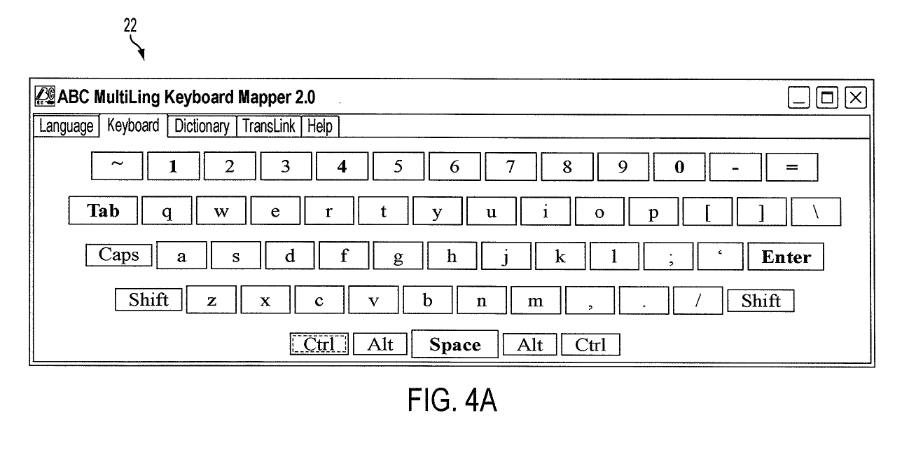

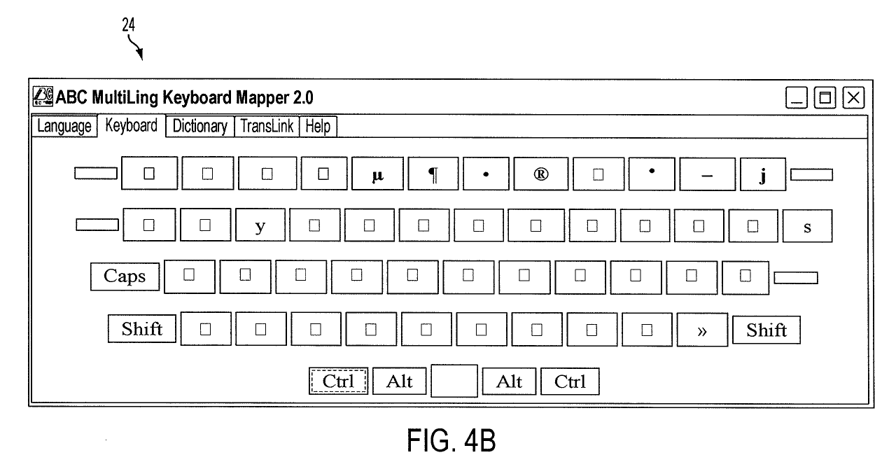

Referring to FIGS. 4A and 4B, the Keyboard tab of the graphical interface is shown. In a preferred embodiment, a default keyboard layer 22 is presented in a first language, such as English. As is indicated in FIG. 4B, the virtual keyboard can have a second layer 24 presented in a second language, and the user can toggle between the first and second layers. For example, the default keyboard layer can be English and the second layer can be the selected language, such as Bulgarian in the preceding example. If a font set requires additional characters to those depicted on the second layer of the virtual keyboard, still another keyboard layer can be added. A user can input characters into the system via the virtual keyboard.

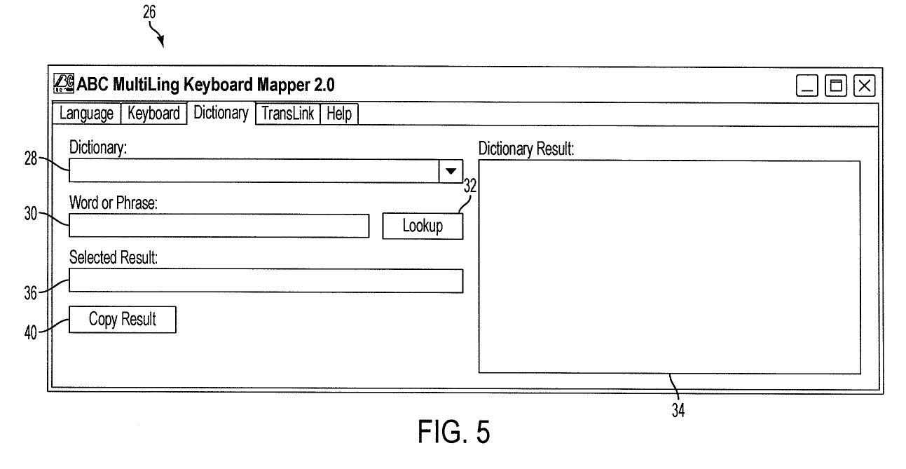

Referring to FIG. 5, the Dictionary tab 26 of the graphical interface is shown. The drop down list box 28 labeled Dictionary allows the user to select a language into which a translation of a word or phrase is required. Selection of a language causes the system to search a database of context specific translations corresponding to that language. In a preferred embodiment, the database can be developed in ACCESS (Microsoft Corp., Redmond, Wash.). By way of illustrative example, an English speaking user can select Chinese from Dictionary drop down list box 28 and enter “rice” in the word or phrase field 30. Pressing the Lookup button 32 or simply pressing the Enter key on the actual keyboard will initiate a search of a multilingual database, containing English words and phrases and one or more context specific Chinese translations of each word or phrase, for information that corresponds in some way to the search term “rice.” The corresponding information, if any, will be retrieved and displayed in the Dictionary Result text area 34. The user can double click on one or more of the displayed results to copy the particular result to the Selected Result field 36. The user can stop after a single selection or can perform successive searches and selections to build a string of text in Selected Result field 36. Selecting the Copy Result button 40 will cause the selection(s) to be copied to a clipboard for eventual use in rendering an output of multilingual information. The selected information can be subjected to further editing to suit the needs of a particular user. In one embodiment, the interface can accept inputs of search terms via selection of an image of an object. Some such embodiments can include a touch screen interface through which a user can make a tactile input of a search term or terms by simply selecting one or more of the displayed objects.

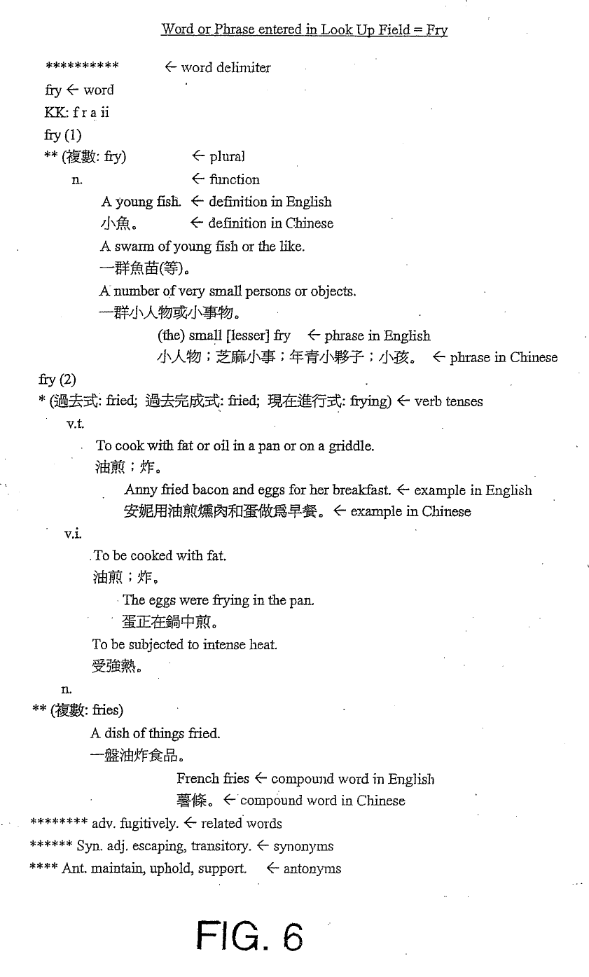

Referring to FIG. 6, an example of the context specific information stored in a multilingual database in the system data store is provided. The information is presented in FIG. 6 in a format similar to that in which the information would appear in the Dictionary Result text area 34 if the search term “Fry” is entered into Word or Phrase field 30 and Lookup button 32 is selected. Context specific definitions for varying functions of the word “fry” are provided and denoted by conventional abbreviations (i.e. n. for noun, v.t. for transitive verb etc.). Additional information including verb tenses, synonyms, and antonyms can also be presented. Search results can further include related words or phrases, such as “french fries,” that correspond to the search term “fry.” A system user is allowed to select none, some or all of the retrieved data, as it applies to a specific context of interest to the user. The user can make multiple selections from a single result set, or can execute multiple searches and multiple selections to build a string of characters for use in rendering multilingual information on an output device. The user can edit the text string built via the search and selection process by entering information via the actual keyboard or the virtual keyboard of the system interface. Thus, the system can be implemented to create a completely customized set of information that is free of context related errors common to pure translation software and, unlike the images can be content edited “on the fly.” One of skill in the art will appreciate that the multilingual database of the present invention can be adapted to include all or portions of the information presented in FIG. 6, and can be further adapted to include additional information not shown such as paragraphs or blocks of address data or shipping and handling instructions.

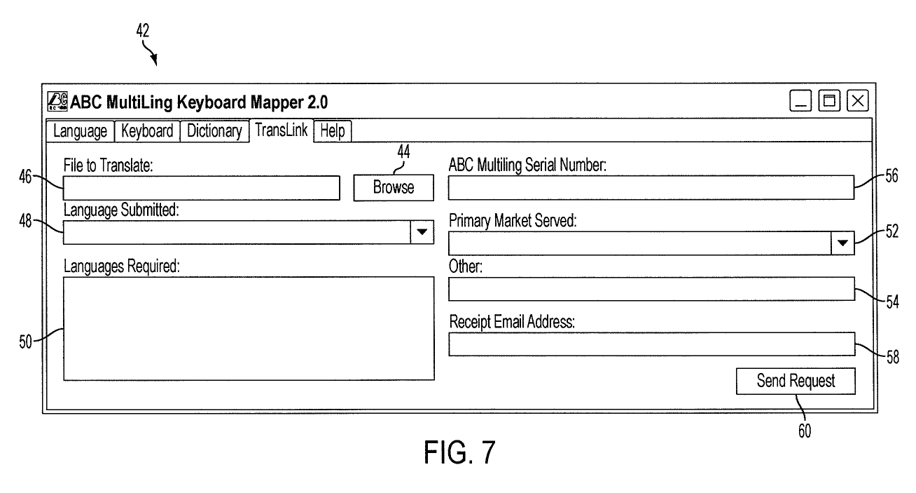

Referring to FIG. 7, the Translink tab 42 of the graphical user interface is shown. In a preferred embodiment, a user can augment an existing database of multilingual information by creating a file of words and/or phrases that require translation from a first language into a second language, electronically transmitting that file to a translation specialist and subsequently receiving back context specific translations that are added to the existing multilingual database in the system data store. By way of illustrative example, an American automobile manufacturer can require English to Portuguese translations of words and/or phrases relating to auto parts. The Translink tab 42 captures the information needed to electronically transfer the file and provide helpful information to the translating service. Selecting the Browse button 44 allows the user to select a previously created file of words and/or phrases from the system data store. One of skill in the art will understand that the file can be in any one of a plurality of formats, including .doc, .xls, .mdb, .ldf, .txt, .rtf, .xml or other equivalent file format for use by word processing, spreadsheet or database applications. The name of the selected file will appear in the File to Translate field 46. The user can indicate the language of the words and/or phrases in the file and the language(s) into which translation is required by making selections from the Language Submitted drop down list box 48 and the Language Required field 50, respectively. The user can provide the industry associated with the words and/or phrases by selecting an industry from the Primary Market Served list box 52 or, if the list does not include the desired industry, by typing the associated industry or other relevant description in the Other field 54. The user provides self-identifying information by typing an alphanumeric string in the Serial Number field 56. Entering the electronic mail address of the recipient in the Recipient Email Address field 58 and pressing the Send Request button 60 causes transmittal of the file to an external party for eventual translation. Completed translations can be returned to the system via electronic transmission and added to the database.

The present invention is capable of rendering multilingual information for use with different forms of automatic identification technology. In a preferred embodiment, the invention can be used to render an output for use in generating compliance documentation containing information selected from a multilingual database by a system user. The information can be rendered in human-readable form (e.g. text composed of alphanumeric characters), machine-readable form (e.g. barcode symbologies), or a combination of both.

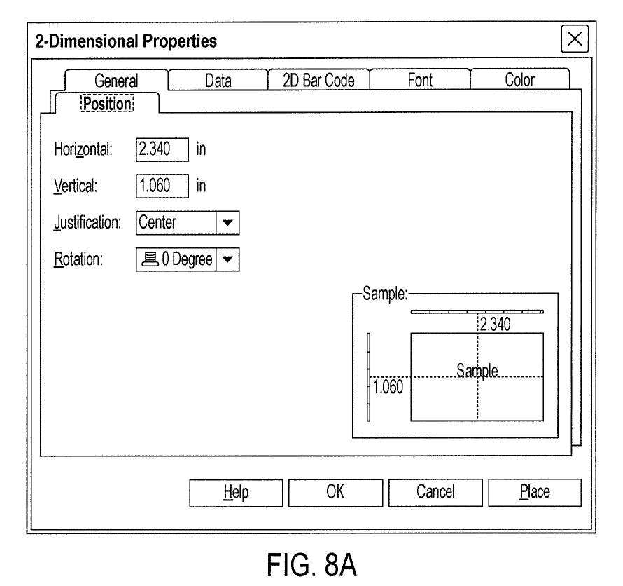

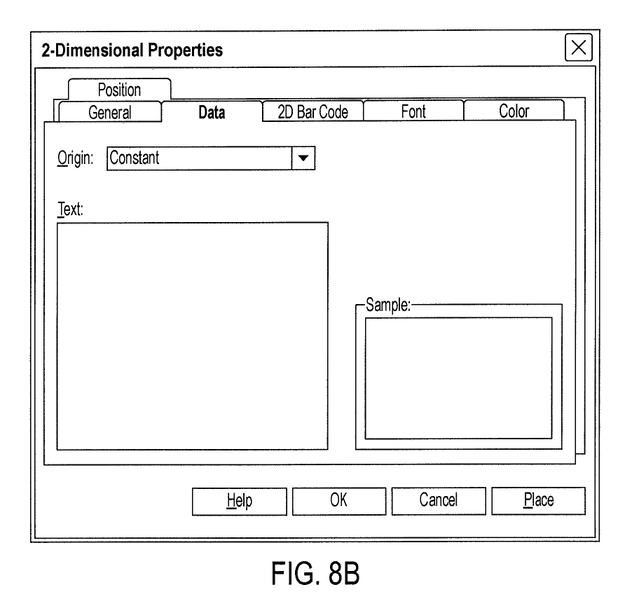

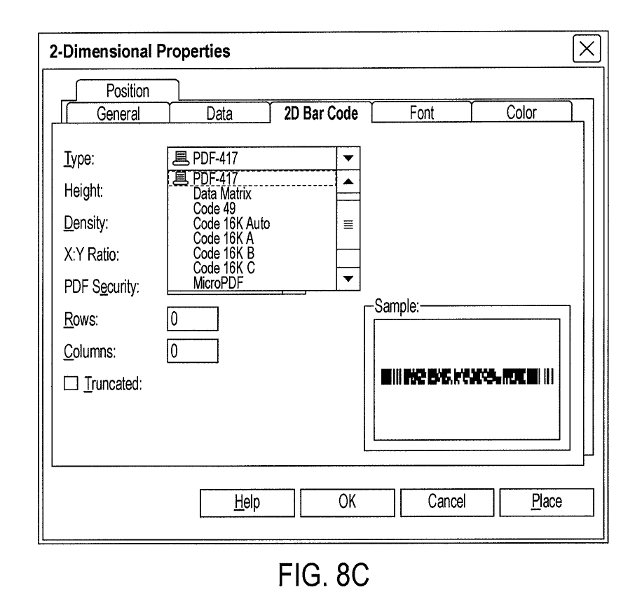

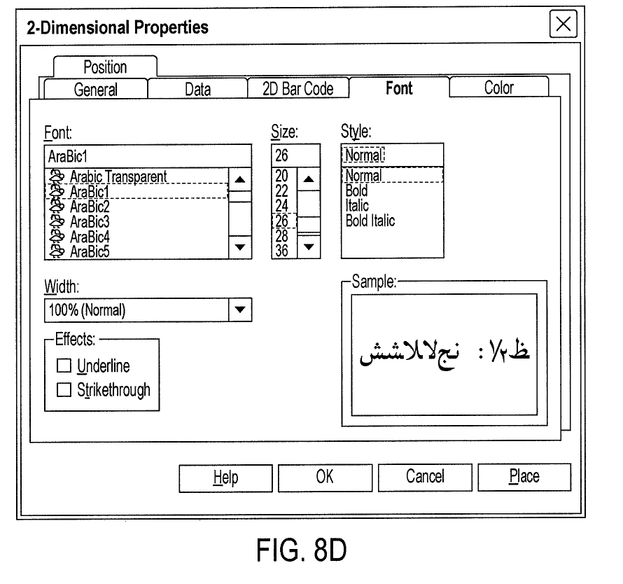

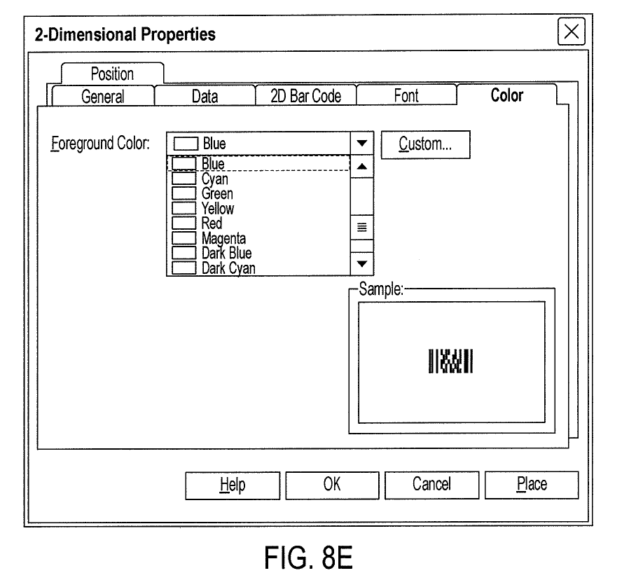

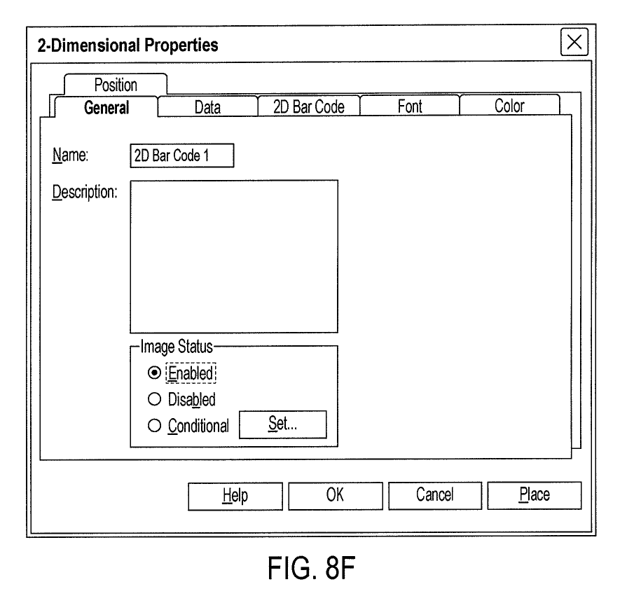

Referring to FIGS. 8A-8F, the present invention in a preferred embodiment provides a system user with a graphical interface for configuring the system to render an output in a particular bar code symbology. The relative position and orientation of the rendered barcode can be defined by specifying the horizontal and vertical position, the justification and the degrees of rotation desired in the appropriate fields of the Position tab depicted in FIG. 8A. The Data tab depicted in FIG. 8B allows a user to specify the source of the data that will be rendered on an output device. A user can make selections from a list to box to specify that the data will originate from user inputs via the keyboard, will be imported from a database such as the multilingual database in the system data store, will take the form of a date or time stamp, will be an incremented or decremented series of values originating from a user specified base value, will be a constant value such as a destination address, or will be any one or more of these in combination. The data that will be output can appear in raw form in the Text box of the Data Tab, and will appear in the form in which it can be rendered on an output device, such as encoded in a particular bar code symbology, in the Sample text area. The 2 DBar Code tab depicted in FIG. 8C allows selection of a particular bar code symbology, such as PDF-417, for use in encoding the selected multilingual information. The selected bar code symbology can be further configured by specifying the data density, the X:Y ratio, and other bar code properties. The present invention, including the interface depicted in the figures, can be adapted for use with any known one dimensional or two dimensional bar code symbology, including without limitation Codabar; Code 39 (3 of 9); Extended 3 of 9; Code 93; Extended 93; Code 128 Auto; Code 128 A, B, and C; EAN/JAN-13; EAN/JAN-8; HIBC; Interleaved 2 of 5; MSI Plessey; UCC-128; UPC-A; UPC-E1 (6 digit); UPC-E (11 digit); UPC-EO (6 digit); Zip+POSTNET; Aztec; Aztec Mesa; Code 16K Auto; Code 16K A, B, and C; Code 49; Data Matrix; EAN/UCC-128; Composite-C; EAN/UPC; Composite; MicroPDF; PDF 417;

QR Code; RSS-14 Composite; TLC39; and UPS MaxiCode. The Font tab depicted in FIG. 8D allows customization of the font, including the size and style that is to be placed in proximity to the bar code, if any. The Color tab depicted in FIG. 8E allows specification of the color in which the bar code symbology will be rendered by an output device. A file for storing a particular configuration of information can be named using the General tab depicted in FIG. 8F. Those of skill in the art will understand that each of the bar code symbology properties alterable via the interface of FIGS. 8A-8F can be set to particular default settings.

In another embodiment, the present invention can be adapted for use in inventory management. A user can scan an inventory of goods with a handheld electronic device, such as a PDA, a PDT, a PPT, CCD, CMOS imager, or a laser scanner equipped with an interface in a first language. The device collects data regarding inventory status and then transfers this data to a computer equipped with a system processor and data store containing a multilingual database. The system can be in any location and the transfer of data can take place over any communication channel. Either the handheld device or the system can generate a request to perform an inventory management function, such as ordering replenishment of a particular stock item. The system can then process the data to perform an inventory management function. Processing the data can include searching for and retrieving multilingual information from the database corresponding to the data delivered from the handheld device the system can render multilingual information on an output device to facilitate fulfillment of the inventory management request. For example, the output device can be a printer that prints multilingual compliance documentation in human-readable and/or machine-readable form, and the compliance documentation can be used to facilitate shipping a quantity of stock items required to replenish the scanned inventory. Under this embodiment, the invention allows placement of an inventory management request in a first language, and processing of that order in a local or remote location in a second language.

In another embodiment, the system processor can be adapted to track the nature and number of searches performed by a system user. Statistical data corresponding to the frequency a particular term is searched, the language in which a translation is sought, the shipping destination of particular goods and other information can be maintained in the system data store. The system can be adapted for use with a communications interface, and the information can be periodically transferred to another system via a communications channel, such as the Internet. Collection of this statistical data can inform market analysis and forecasting needs for system users.

In another embodiment, the multilingual database is hosted at a remote location. The system processor is adapted to track searches run against this remote database and to accrue charges for the hosting service.

In one preferred embodiment, interfaces previously described and depicted can be implemented through web pages accessible via a web server. The web server has access to the remotely located multilingual database, and in some embodiments a remotely located or local template database. A user can enter search terms and generate multilingual output through use of a standard web browser.

The above-described embodiments are given as illustrative examples only. It will be readily appreciated that many deviations can be made from the specific embodiments disclosed in this specification without departing from the invention. Accordingly, the scope of the invention is to be determined by the claims below rather than being limited to the specifically described embodiment above.

1. A system for rendering multilingual information on an output device, the system comprising:
a system data store capable of storing a database of multilingual information and fonts associated with multiple languages, the database including context specific definitions of words translated into multiple languages;
a system processor comprising one or more processing elements, in communication with the system data store, wherein the system processor is programmed or adapted to:
a. provide a search term interface via which a user can specify a search term in a selected one a plurality of languages;
b. receive the specified search term in the selected language via the search term interface;
c. if a database of multilingual information is not present in the system data store, receive and store a database of multilingual information, wherein the database includes context specific definitions of words translated into multiple languages;
d. search the database for at least one context specific translation in a second language different than the selected language based upon the received search term;
e. provide and display the specified search term and the search results to a user in a translation interface;
f. receive a user selection of a displayed context specific translation from the translation interface; and
g. provide information comprising at least a portion of the user selected context specific translation in the selected language and the second language in a format compatible with a selected output device.

2. The system of claim 1, wherein the information is adapted for rendering on an output device in the form of a bar code symbology.

3. The system of claim 2, wherein the information is adapted for rendering on an output device in the form of a one dimensional bar code symbology.

4. The system of claim 2, wherein the information is adapted for rendering on an output device in the form of a two-dimensional bar code symbology.

5. The system of claim 1, wherein the information is adapted for rendering on an output device in human-readable form in at least two languages.

6. The system of claim 1, wherein the system data store is further capable of storing a collection of document templates.

7. The system of claim 6, wherein the system processor is programmed or adapted to allow user creation of document templates in any combination of languages.

8. The system of claim 6, wherein the system data store stores a collection of document templates comprising one or more label templates, one or more invoice templates or one or more packing slip templates, one or more bill of lading templates, one or more certificate of authenticity templates, or combinations thereof in any combination of languages.

9. The system of claim 1, and further comprising a communications interface adapted to connect the system with a communications channel, wherein the system processor is in further communication with the communications interface, and wherein the system processor is further programmed or adapted to initialize and/or update a collection of document templates in the system data store with data received via the communications interface.

10. The system of claim 1, wherein the user interface comprises a touch screen.

11. The system of claim 10, wherein the system processor is programmed or adapted to accept the search term by presenting on the user interface one or more images of objects for which a context specific translation are available and receiving from the user interface an indication of the search term.

12. The system of claim 1, further comprising a communications interface adapted to connect the system with a communications channel, wherein the system processor is in further communication with the communications interface.

13. The system of claim 12, wherein the system processor is further programmed or adapted to initialize and/or update the database of multilingual information in the system data store with data received via the communications interface.

14. The system of claim 12, wherein the communications interface is a bus interface, a network interface or a modem.

15. The system of claim 1, and further comprising the output device and wherein the system processor is in further communication with the output device.

16. A method of rendering encoded multilingual information by an output device, the method comprising the steps of:
receiving a database of multilingual information, wherein the database contains context specific translations of words in multiple languages;
storing the database in a system data store;
retrieving information corresponding to a search term in a selected one of a plurality of languages from the database in the format of a second language different from the selected language, wherein the information comprises one or more context specific translations in the second language of the search term in the selected language;
displaying the information comprising the specified search term in the selected language and the one or more context specific translations in the second language to a user;
receiving a user selection of a displayed context specific translation from the translation interface; and
adapting at least a portion of the specified search term in the selected language and the one or more context specific translations in the second language for rendering by an output device in both the selected language and second languages, wherein the output device comprises direct parts marking equipment or equipment for transferring data to contact read/write devices.

17. The method of claim 18, further comprising the step of tracking the number of searches and the type of information retrievals performed.

18. A method of using multilingual information to effect inventory management, the method comprising the steps of:
scanning an inventory with an electronic device to collect data regarding inventory status;
transferring a portion of the data from the electronic device to a computer via a communications channel, the data being represented in a first language;
creating an inventory request according to the data;
processing the data and the inventory request with the computer, the processing including searching a database of multilingual information for information corresponding to the request; and
rendering multilingual information for use by an output device to facilitate fulfillment of the request, wherein the output device comprises direct parts marking equipment or equipment for transferring data to contact read/write devices.
